(19) United States
(12) Patent Application Publication
(10) Pub. No.: US 2026/0336174 A1
(43) Pub. Date: Oct. 29, 2026

(54) METHOD AND INJECTION-MOULDING DEVICE FOR INJECTION MOULDING OF PLASTICS PARTS

(71) Applicant: Eli Lilly and Company, Indianapolis, IN (US)

(72) Inventors: Frank HENNINGER, Ettenheim (DE); Jakob WILLMANN, Schallstadt (DE); Hans-Jürgen AMBERG, Hinterzarten (DE); Winfried EBNER, Emmendingen (DE); Murat GÜNAY, Carmel, IN (US); Ho Seon JIN, Carmel, IN (US)

(21) Appl. No.: 19/115,354

(22) PCT Filed: Sep. 27, 2023
(86) PCT No.: PCT/EP2023/076749

§ 371 Date: Mar. 26, 2025

(30) Foreign Application Priority Data
Sep. 27, 2022 (DE) 102022124825.9
Nov. 24, 2022 (DE) 102022131109.0

(51) Int. Cl. B29C 45/73; B29C 45/14; B29C 45/78

(52) U.S. Cl. CPC B29C 45/7306; B29C 45/14; B29C 45/78; B29C 2945/7604; B29C 2945/76257; B29C 2945/76531; B29C 2945/76735

(57) ABSTRACT

The invention relates to improvements in the field of injection molding technology. Among other things, a method for injection molding plastics parts (2) is proposed as an improvement, in which, to produce a plastics part (2), liquefied plastics material is injected into a mold cavity (4) of an injection molding tool (3) equipped with a core (5). The method is characterized in that the core (5) is inductively heated before the plastics material is injected.

### BACKGROUND

The invention relates to a method and to an injection molding device for injection molding plastics parts, in particular medical products. To produce a plastics part, liquefied plastics material is injected into a mold cavity of an injection molding tool equipped with a core.

By using a core as part of the shaping injection molding tool, it is possible to produce plastics parts that have cavities.

### SUMMARY

In one embodiment, a method for injection molding a plastics part is proposed, in which, an injectable plastic materials, such as liquefied plastics material, is injected into a mold cavity of an injection molding tool equipped with a core. The core is inductively heated before being inserted into the mold cavity and the plastics material is injected. The core can be inductively heated outside of the mold cavity.

In another embodiment, an injection molding device for injection molding a plastic part. The device include an injection molding tool having a mold cavity, a core, an inductive heating device, and a control unit configured to execute computer-readable instructions that cause the control unit to: Inductively heat the core with the inductive heating device outside of the injection molding tool. Insert the inductively heated core into the mold cavity. Inject an injectable plastics material into the mold cavity to produce a plastic part.

### BRIEF DESCRIPTION OF THE DRAWINGS

The invention is described in more detail below using an embodiment, but is not limited to this embodiment. Further embodiments are obtained by combining the features of individual or multiple claims with one another and/or by combining individual or multiple features of the embodiment. In the drawings:

FIG. 1 shows a perspective view of an injection molding device with an injection molding tool that has a nozzle-side mold half and an ejector-side mold half that form a total of four mold cavities between them, with a total of four groups of cores that can be moved between individual stations of the injection molding device along a closed path of movement of a transport device, and with an inductive heating device, which has four inductive heating coils for inductively heating the cores,

FIG. 2 shows a perspective view of the injection molding device shown in FIG. 1 with the injection molding tool closed, the four inductive heating coils of the inductive heating device being arranged in a heating position on four cores located on the inductive heating device in the heating position,

FIG. 3 shows the injection molding device shown in FIGS. 1 and 2 with the injection molding tool open, wherein four injection-molded plastics parts in the form of plastics springs can be seen on the four cores arranged on the injection molding tool,

FIG. 4 shows an exploded overview with a core, a plastics part, an insert part, which is at least partially overmolded with plastics material during production of the plastics part, as well as a nozzle-side mold half and an ejector-side mold half of the injection molding tool of the injection molding device shown in FIG. 1-3,

FIG. 5 shows a partially sectioned view of a core equipped with an insert in its heating position inside an inductive heating coil of the inductive heating device shown in FIG. 1-3,

FIG. 6 shows a sectional view of the plastics part shown in FIG. 4, and

FIG. 7 shows a perspective view of the plastics part shown in FIG. 6 with a partially overmolded insert at its tip, the plastics part being a coiled plastics spring.

### DETAILED DESCRIPTION

The object of the invention is to provide a method and an injection molding device for injection molding injection-molded plastics parts, which are particularly suitable for the production of plastics parts with a relatively large ratio of surface area to material volume.

In order to achieve the object, a method for injection molding plastics parts is first proposed, which has the means and features of the independent claim related to a method of this type.

In order to achieve the object, a method for injection molding plastics parts, in particular medical products, is proposed, in which, to produce a plastics part, liquefied plastics material is injected into a mold cavity of an injection molding tool equipped with a core. According to the invention, the method is characterized in that the core is inductively heated before the plastics material is injected.

The invention is based on the finding that difficulties can arise during injection molding due to the cores in the production of plastics parts, which have a comparatively large surface area in relation to their material volume. These difficulties are caused by the fact that the cores remove heat from the plastics material injected into the mold cavity to produce the plastics parts, which can adversely affect the quality of the plastics parts produced in the injection molding method. It is particularly problematic if the cores have a particularly large material volume in relation to the volume of the mold cavity that is filled with the plastics material for the production of the plastics parts. The cores can then act like heat sinks, which extract the heat from the injected plastics material comparatively quickly.

The inductive heating of the core provided according to the invention before the injection of the plastics material makes it possible to reduce or even completely avoid heat extraction caused by the core from the plastics material injected into the mold cavity during production of the plastics part. The inductive heating of the core has the particular advantage that it can take place particularly quickly, energy-efficiently and therefore economically for the manufacturing process.

In one embodiment of the method, it is provided that the core, in particular at least one shaping surface of the core, is heated to a temperature between 50 °C and 100 °C, in particular to a temperature between 60 °C and 80 °C. Heating the core, in particular at least its shaping surface, to a temperature of this type can promote a particularly efficient implementation of the method and the production of plastics parts of the desired quality.

In one embodiment of the method, it is provided that at least one shaping surface of the core is heated during the inductive heating of the core. This ensures that at least the shaping surface of the core that comes into contact with the melted plastics material is heated before the plastics material is injected. The injected plastics material then hits the inductively heated surface of the core inside the mold cavity. This prevents the core from drawing heat from the plastics material too quickly.

In one embodiment of the method, the core is inductively heated inside the injection molding tool, in particular inside the mold cavity, preferably when the injection molding tool is open.

In another embodiment of the method, it is provided for the core to be inductively heated outside of the injection molding tool and thus outside of the mold cavity and then to be inserted into the mold cavity of the injection molding tool.

In this embodiment of the method, the core is first inductively heated outside of the injection molding tool and, after the inductive heating, is inserted into the injection molding tool and its mold cavity. The injection molding tool and thus the mold cavity can then be closed. This variant of the method is advantageous since comparatively short cycle times can be achieved when carrying out the method.

The inductive heating of a core can take place outside of the injection molding tool, while another, already inductively heated core can be arranged inside the mold cavity for carrying out the method. The injection molding tool can thus be used independently of the inductive heating of a core for the production of plastics parts. In this way, down times during which the injection molding tool and its at least one mold cavity cannot be used to produce plastics parts can be reduced or even completely avoided.

The core can be heated with an inductive heating coil of an inductive heating device. In this case, the core for inductive heating can be arranged inside the inductive heating coil. The use of an inductive heating coil allows the core to be heated on the outside and thus on the surface. As will be explained in more detail below, this can promote comparatively rapid cooling of the plastics parts on the core.

In order to arrange the core inside the inductive heating coil, it can be provided that the inductive heating coil is slipped over the core or that the core is inserted into the inductive heating coil.

It is advantageous if the inductive heating coil has a receiving space for the core with an inner contour adapted to an outer contour of the core, preferably an inner contour adapted to a shaping surface of the core, and/or inductively heats at least the shaping surface of the core.

The inner contour of the receiving space of the heating coil can correspond to the outer contour of the core, in particular its shaping surface. In this way, a uniform heating of the surface of the core, which at least partially delimits the mold cavity, is possible when the core is inserted into the mold cavity.

The core can be superficially heated by inductive heating. The core can preferably consist of a solid material and/or be designed at least substantially without cavities. It is thus possible for the inductive heating of the core, in particular at least one shaping surface of the core, to result in a temperature gradient between the heated surface of the core and an inner region of the core that is heated less or not at all. Due to the fact that the surface, in particular the shaping surface of the core, is heated, premature heat extraction from the plastics material injected into the mold cavity can be avoided.

However, if the core is not heated through, but preferably substantially only its shaping surface is heated, this has advantages during the subsequent cooling of the injection-molded plastics parts. Due to the aforementioned temperature gradient, the material of the core in the inner region of the core can absorb the heat of the injection-molded plastics part from the plastics material and dissipate it from the plastics part. Despite the inductive heating of the core, this allows for rapid cooling of the injection-molded plastics part on the core and thus also the shortest possible cycle times when carrying out the method.

The inductive heating of the core can be monitored using a temperature sensor. It is also possible to regulate the inductive heating of the core with a control unit. In this case, the inductive heating of the core can be regulated by the control unit depending on a temperature of the core to be inductively heated, which temperature is determined using the temperature sensor.

It is advantageous if the inductive heating of the core takes place immediately before the plastics material is injected into the mold cavity. This promotes an energy-efficient carrying out of the method, since the time in which the core can cool before injecting the plastics material is reduced in this way, and the core thus only has to be heated to a temperature which is only slightly higher than the temperature which the core should have when injecting the plastics material into the mold cavity.

In one embodiment of the method, at least one insert, for example a pin, a medical lancing device, and/or an RFID chip, is inserted into the mold cavity and at least partially overmolded with the plastics material. In this way, it is possible to produce a plastics part which has an at least partially overmolded insert. The method can be carried out particularly efficiently if the at least one insert part is arranged on the core and/or is inserted with the core into the mold cavity. Thus, the core can be used not only as a shaping part of the injection molding tool but also as a holder and/or means of transport for the at least one insert.

If the insert has an electrical and/or electronic function, for example because it is designed in the form of an RFID chip, it can be advantageous to equip the core with the insert only after inductive heating. In this way, damage to and/or a functional impairment of the insert due to the inductive heating of the core is avoided. If the insert is not affected by the inductive heating, equipping of the core with the insert can take place before inductive heating.

After its production, the plastics part can initially remain on the core and be held by it. It is also possible to remove the plastics part together with the core from the mold cavity and/or the injection molding tool and leave it on the core to cool.

For inductive heating of the core, the core and the heating coil can be arranged at a distance of 1-5 mm, in particular 0.5-2 mm, particularly preferably 0.2-1 mm relative to one another. This can take place with a positioning device. The positioning device can be set up to move the core into the heating coil and/or to slip the heating coil over the core.

In one embodiment of the method, the mold cavity and the core are designed in such a way that a plastics part in the form of a plastics spring is produced as part of the method. The core can also be used as a means of transport for removing the plastics part from the mold cavity of the injection molding tool and/or from the injection molding tool. It is also possible that the plastics part remains on the core after the injection molding and cools there.

A plastics spring, in particular a coiled plastics spring, can be produced as the plastics part. The plastics spring can, for example, have a ratio of coil length to coil width of between 20:1 and 100:1, in particular 50:1, and/or, for example, a ratio of coil thickness, which can be measured transversely to the longitudinal axis of the plastics spring to coil width, which can be measured in the direction of the longitudinal axis of the plastics spring, of between 1:2 and 1:10, in particular 1:5.

To achieve the object, an injection molding device for injection molding plastics parts, in particular medical products, is also proposed, which has the means and features of the independent claim related to an injection molding device of this type. In order to achieve the object, an injection molding device is proposed in particular, which is set up for injection molding plastics parts, the injection molding device comprising at least one injection molding tool having at least one mold cavity, at least one core, which is arranged in the mold cavity for injection molding a plastics part, and an inductive heating device, which is set up for inductively heating the at least one core, in particular at least one shaping surface of the at least one core, before the injection molding of the plastics part.

The inductive heating device of the injection molding device can be set up in particular to heat the at least one core, in particular at least one shaping surface of the at least one core, to a temperature between 50 °C and 100 °C, preferably to a temperature between 60 °C and 80 °C. The inductive heating of the at least one core, in particular at least its shaping surface, to a temperature from these temperature ranges can be particularly favorable in order to produce plastics parts of the desired quality.

The injection molding device can be set up to carry out the method already explained above and thus to carry out the method according to any of the claims related to such a method.

The injection molding device can have a control unit and/or at least one temperature sensor. The control unit can be set up to regulate the inductive heating device depending on a temperature of the core to be inductively heated, which temperature is determined using the at least one temperature sensor.

The inductive heating device can have at least one inductive heating coil, by means of which the inductive heating device is set up for inductively heating the at least one core, in particular at least its shaping surface. For this purpose, the heating coil can have a receiving space for receiving a core to be heated. A particularly efficient inductive heating is promoted when the shape or inner contour of the receiving space is adapted to the shape or outer contour of the core to be heated.

If the injection molding tool has a plurality of mold cavities, it is advantageous if the inductive heating device has a number of inductive heating coils that corresponds to the number of mold cavities in the injection molding tool. In this way, all mold cavities can each be equipped with an inductively heated core at the same time.

It is particularly advantageous if the injection molding device comprises a plurality of groups of cores, each group of cores having a number of cores that corresponds to the number of mold cavities in the injection molding tool. In this way, it is possible to inductively heat one group of cores outside the mold cavities while another group of cores is arranged in the mold cavities for injection molding plastics parts. Another group of cores, with plastics parts located thereon, may remain in a position outside of the injection molding tool and its mold cavities for cooling the plastics parts. A further group of cores can, for example, be arranged in an equipping position for equipping with inserts.

In one embodiment of the injection molding device, the at least one mold cavity and the core assigned to the mold cavity are designed such that a plastics part in the form of a plastics spring, in particular a coiled plastics spring, is produced when the mold cavity is filled with plastics material. The plastics spring can, for example, have a ratio of coil length to coil width of between 20:1 and 100:1, for example a ratio of 50:1, and/or a ratio of coil thickness, which can be measured transversely to the longitudinal axis of the plastics spring to coil width, which can be measured in the direction of the longitudinal axis of the plastics spring, of between 1:2 and 1:10, in particular 1:5.

The injection molding device, in particular its inductive heating device, can have a positioning device. With the positioning device, it is possible to bring the at least one heating coil into a heating position on the at least one core or the at least one core into a heating position on the at least one heating coil.

The at least one inductive heating coil and the at least one core can be arranged at a distance of 1-5 mm, preferably 0.5-2 mm, and particularly preferably 0.2-1 mm from one another in the heating position during inductive heating of the core. In this way, energy-efficient and fastest possible inductive heating of the core, in particular of its shaping surface, is promoted.

The inductive heating device can be set up for inductively heating the at least one core inside and/or outside the injection molding tool, in particular the mold cavity.

The injection molding device can have a transport device. The transport device can be designed, for example, as a rotary indexing table. The transport device can be set up to transport the at least one core from a heating position into the injection molding tool and in particular into the mold cavity. The core can be transported with the transport device from a heating position located outside of the mold cavity on the inductive heating device into the injection molding tool and preferably thus into the mold cavity.

The transport direction can also be set up to transport the at least one core, in particular with a plastics part arranged thereon, out of the mold cavity into a removal position outside of the mold cavity. In the removal position, the plastics part can then initially cool on the core and then be removed from the core. In this way, the core functions not only as a shaping part of the injection molding tool, but also as a means of transport with which the injection-molded plastics parts can be removed from the mold cavity of the injection molding tool.

The injection molding device can have a removal device with which a plastics part can be removed from the at least one core, in particular after it has cooled. For this purpose, the removal device can have at least one removal gripper. It is advantageous if the removal device has a number of removal grippers that corresponds to the number of mold cavities in the injection molding tool. In this way, it is possible to remove all plastics parts produced in an injection molding step in one removal process.

The injection molding device can be set up for the at least partial overmolding of inserts, in particular pins and/or medical lancing devices and/or RFID chips.

In this context, it can be advantageous if the at least one core is set up to hold at least one insert part that is to be at least partially overmolded. The core can, for example, be equipped with an insert outside of the mold cavity of the injection molding tool and then inserted together with this into the mold cavity. This is preferably done after the core has been inductively heated. Equipping of the core can take place with the insert before or after heating of the core.

The injection molding device can have an insertion device with which insert parts can be arranged on the at least one core. For this purpose, the insertion device can have at least one insertion gripper.

The injection molding device can comprise an injection molding machine with which plastics material can be injected into the at least one mold cavity of the injection molding tool of the injection molding device.

The injection molding tool can have a nozzle-side mold half and an ejector-side mold half, between which the at least one mold cavity is designed.

The control unit can be set up to control functional units of the injection molding device, in particular to control the injection molding tool, in particular its opening and closing movement, and/or the inductive heating device and/or the positioning device for moving the at least one inductive heating coil between an initial position and a heating position and/or the transport device and/or the removal device with its removal gripper and/or the equipping device with its equipping gripper and/or the injection molding machine.

The aforementioned control unit of the injection molding device can have a data interface with which the control unit can be connected at least temporarily to a data memory, for example to a cloud-based data memory.

A computer program can be stored in the data memory, which comprises commands that cause the injection molding device according to the invention to carry out the steps of the method according to the invention.

To achieve the object, a computer program is thus also proposed that comprises commands that cause the claimed injection molding device to carry out the steps of the claimed method. The computer program can be executed, for example, on the aforementioned control unit of the injection molding device. In this case, the control unit can convert the commands of the computer program into control commands in order to correspondingly control the aforementioned functional units of the injection molding device, which are respectively used to carry out the steps of the method. The control unit can act as a control computer that is set up to run the computer program.

To achieve the object, a computer-readable medium is also proposed on which the computer program according to the invention is stored. For example, a computer-readable data memory, in particular a cloud-based data memory, can serve as the computer-readable medium. The computer-readable medium can in particular be the aforementioned cloud-based data memory, to which the injection molding device can be connected at least temporarily via the data interface of its control unit.

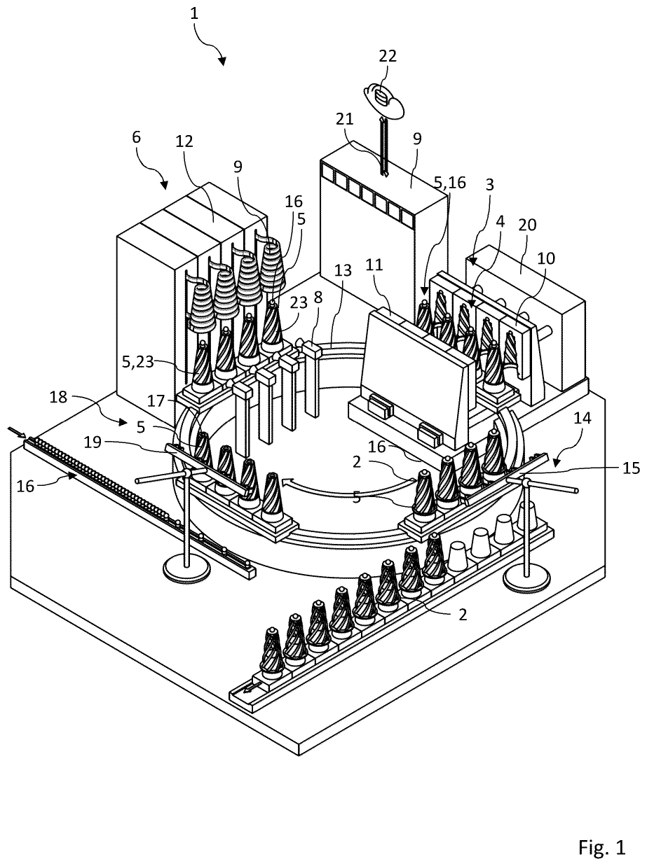

FIG. 1-3 show an injection molding device designated 1 as a whole. The injection device 1 is set up for the production of injection-molded plastics parts 2, namely coiled plastics springs, which can be used, for example, as part of a medical injection device or a medical blood collection device.

The injection molding device 1 comprises an injection molding tool 3 with a total of four mold cavities 4.

Furthermore, the injection molding device 1 has a total of four groups of four cores 5 each, which can be arranged in the mold cavities 4 of the injection molding tool 3 for injection molding plastics parts 2.

The injection molding device 1 also has an inductive heating device 6 which is located upstream of the injection molding tool 3 and is set up for inductively heating the cores 4 before the plastics parts 2 are injection-molded. The inductive heating device 6 of the injection molding device 1 is set up to heat the cores 5, namely at least their shaping surfaces 23, to a temperature between 50 °C and 100 °C, preferably to a temperature between 60 °C and 80 °C.

The injection molding device 1 comprises a control unit 7 and a total of four temperature sensors 8. The control unit 7 is set up to regulate the inductive heating device 6 depending on the temperatures of the cores 5 to be heated, which are determined using the temperature sensors 8. The inductive heating device 6 has a total of four inductive heating coils 9. The inductive heating device 6 is set up by the inductive heating coils 9 to simultaneously inductively heat four cores 5 of one of the four individual groups of cores 5. When heating the cores 5, it is above all the shaping surfaces 23 of the cores 5 that are heated, with which plastics material comes into contact during the injection molding of the plastics parts 2 in the mold cavities 4.

The inductive heating device 6 thus has a number of inductive heating coils 9 which corresponds to the number of mold cavities 4 of the injection molding tool 3.

The mold cavities 4 and the cores 5 assigned to the mold cavities 4 are designed in such a way that plastics parts 2 in the form of coiled plastics springs are produced when the corresponding mold cavity 4 is filled with plastics material.

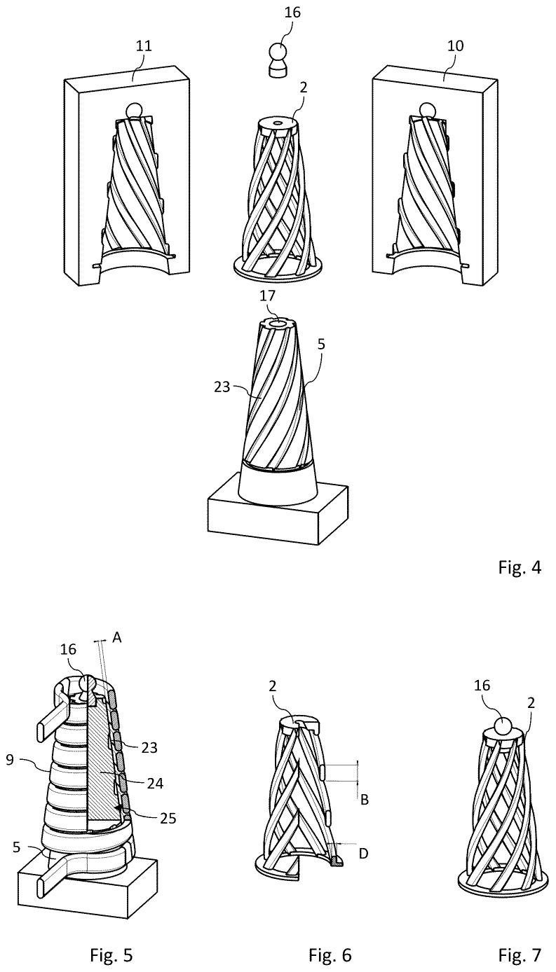

In particular, the overview from FIG. 4 illustrates the shape of the cores 5, their shaping surfaces 23, which take up the helical shape of the plastics parts 2, as well as the shape of the mold cavities 4 specified by the two mold halves 10 and 11 and also the shape of the plastics parts 2 that can be produced in the injection molding tool 3.

The plastics springs that can be produced as plastics parts 2 with the injection molding device 1 can have a ratio between coil length and coil width B of between 20:1 and 100:1, for example a ratio of 50:1. The plastics springs can, for example, also have a ratio of coil thickness D, which can be measured transversely to the longitudinal axis of the plastics springs, to coil width B, which can be measured in the direction of the longitudinal axis of the plastics spring, of between 1:2 and 1:10, particularly preferably a ratio of about 1:5.

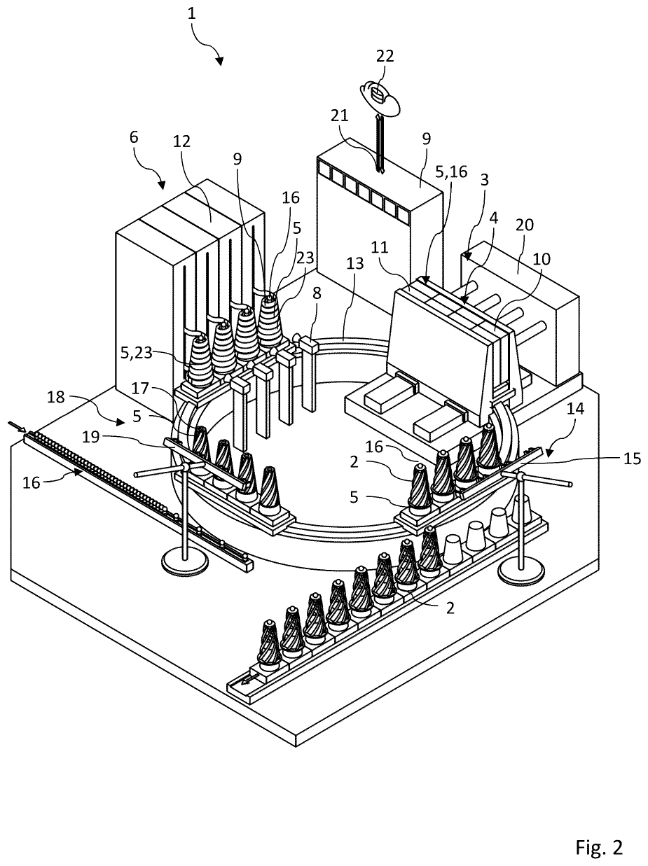

The inductive heating device 6 has a positioning device 12. The positioning device 12 serves to move the four inductive heating coils 9 from their initial position shown in FIG. 1 to their heating position on the cores 5 shown in FIG. 2. In their heating position, the heating coils 9 are slipped over the cores 5 to be heated.

The cores 5 are arranged inside the heating coils 9 in the heating position. The heating coils 9 have a shape that is adapted to the shaping surfaces 23 and the outer contour of the cores 5. In the heating position, the inductive heating coils 9 and the cores 5 arranged in the heating coils 9 are arranged at a distance of 1-5 mm, preferably 0.5-2 mm, particularly preferably 0.2-1 mm from one another.

The inductive heating device 6 is set up for inductively heating the cores 5 outside the injection molding tool 3 and outside its mold cavities 4.

In the case of an injection molding device (not shown in the drawings), the cores 5 can also be heated in their position inside the injection molding tool 3 or inside the mold cavities 4 using a correspondingly designed heating device 6. This is preferably done when the injection molding tool 3 is open.

The injection molding device 1 has a transport device 13. The transport device 13 is designed as a rotary indexing table and set up to transport the four groups of four cores 5 each from their heating position on the heating device 6 into the mold cavities 4 of the injection molding tool 2. The cores 5 move from the heating position located outside of the injection molding tool 3 and the mold cavities 4 on the inductive heating device 6 into the injection molding tool 3 and finally into the mold cavities 4 of the injection molding tool 3.

The inductive heating device 6 and the injection molding tool 3 are arranged adjacent to one another at an angular distance of 90° on the outer circumference of the transport device 13. In this way, the cores 5 can be moved directly into the injection molding tool 3 and its mold cavities 4 after the inductive heating.

FIG. 1 shows a group of already heated inductive cores 5 in a position between two mold halves 10 and 11 of the open injection molding tool 3.

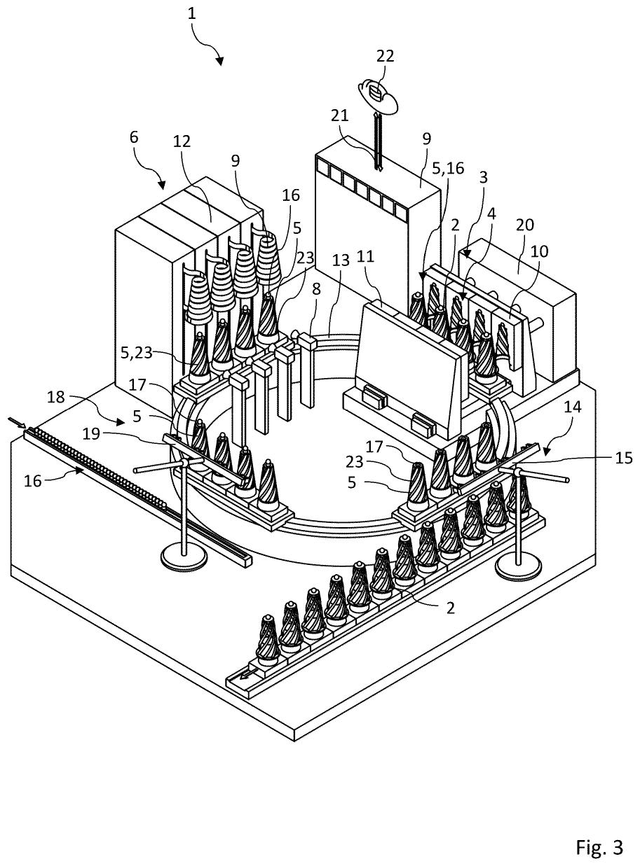

In FIG. 2, the injection molding tool 3 is then shown closed and plastics material is injected into the mold cavities 4, which are delimited by the mold halves 10 and 11, for the production of the plastics parts 2. FIG. 3 shows the plastics parts 2 immediately after opening the injection molding tool 3.

From this position, the plastics parts 2 can be moved, using the transport device 13, together with the cores 5 from the injection molding tool 3 to a downstream cooling position, which also serves as a removal position for the injection-molded parts 2.

The injection molding device 1 has a removal device 14 at the removal position. The removal device 14 comprises a removal gripper 15 with which the plastics parts 2 can be removed from the cores 5 and deposited after they have cooled.

The injection molding device 1 is set up for the at least partial overmolding of inserts 16, for example pins, medical lancing devices, and/or RFID chips. The inserts 16 are shown in FIG. 1-3 and in particular also in FIGS. 4, 5, and 7.

In particular when inserts 16 are used which have an electronic function, for example RFID chips, it can be advantageous to arrange the inserts 16 on the cores 5 only after heating the cores 5.

In the embodiment of the injection molding device 1 shown in the drawings, the cores 5 are each set up to hold an insert part 16 to be overmolded. For this purpose, the cores 5 each have a receptacle 17 at their upper ends in the drawings, into which the inserts 16 can be inserted. In order to equip the cores 5 with the inserts 16, the injection molding device has an equipping device 18. The equipping device 18 has an equipping gripper 19 with which the inserts 16 can be arranged on the cores 5.

The injection molding device 1 has an injection molding machine 20 adjacent to its injection molding tool 2. Plastics material can be injected into the mold cavities 4 of the injection molding tool 3 of the injection molding device 1 using the injection molding machine 20.

The control unit 7 has a data interface 21 with which it can at least temporarily record a data connection to a computer-readable medium 22, namely a cloud-based data memory. A computer program is stored in the cloud-based data memory, which comprises commands that cause the injection molding device 1 to carry out the method for injection molding plastics parts 2 that is described in detail below.

According to the computer program, the control unit 7 then controls the functional units of the injection molding device 1, namely the injection molding tool 3, the inductive heating device 6, the positioning device 12 for moving the inductive heating coils 9, the transport device 13, the removal device 14 with the removal gripper 15, the equipping device 18 with the equipping gripper 19 and also the injection molding machine 20 to carry out the method and produce the plastics parts 2.

It is provided that liquefied plastics material for the production of plastics parts 2 is injected into the mold cavities 4 of the injection molding tool 3 equipped with cores 5. Before injecting of plastics material takes place into the mold cavities 4, the cores 5 are inductively heated, with at least their shaping surfaces 23 being heated.

In the embodiment of the injection molding device 1 shown in the drawings, it is provided that the cores 5 are inductively heated outside of the injection molding tool 3 and its mold cavities 4. The cores 5 are inductively heated on the inductive heating device 6 of the injection molding device 1 and thus outside the mold cavities 4 and then inserted directly into the injection molding tool 3 and into the mold cavities 4. The injection molding tool 3 is then closed by approaching the ejector-side mold half 11 to the nozzle-side mold half 10.

The cores 5 are heated with the inductive heating coils 9 of the inductive heating device 6. This takes place when the cores 5 are arranged inside the heating coils 9. In the embodiment of the injection molding device 1 shown in the drawings, the inductive heating coils 9 are slipped over the cores 5 for this purpose. Once this has taken place, the inductive heating device 6 is activated in order to heat the cores 5 using the inductive heating coils 9. The drawings show that the shape of the heating coils 9 is adapted to the shape of the cores 5 to be heated. For this purpose, the heating coils 9 have receiving spaces 25 for receiving the cores 5 to be heated, the shape of which is adapted to the shape of the cores 5 to be heated.

Due to the inductive heating of the cores 5, the cores 5 are superficially heated in the region of their corresponding shaping surface 23. According to FIG. 5, the cores 5 consist of a solid material and are designed at least predominantly without cavities. The inductive heating creates a temperature gradient between the heated, shaping surface 23 of the corresponding core 5 and an inner region 24 of the corresponding core 5 that is heated less or not at all. This temperature gradient promotes quick cooling of the plastics part 2 that is injected around the core 5.

The inductive heating device 6 of the injection molding device 1 is set up to heat the cores 5, in particular at least their shaping surfaces 23, to a temperature between 50 °C and 100 °C, preferably to a temperature between 60 °C and 80 °C.

The inductive heating of the cores 5 is monitored using the already mentioned temperature sensors 8. In this case, the inductive heating of the cores 5 is regulated by the control unit 7 of the injection molding device 1. As soon as the temperature sensors 8 determine that the desired setpoint temperature of the cores 5 has been reached, for example when at least the shaping surfaces 23 of the cores 5 have reached a temperature between 60 °C and 80 °C, the inductive heating device 6 can be deactivated using the control unit 7 and the heating of the cores 5 can be stopped.

Before the cores 5 are inductively heated on the heating device 6, they are equipped with the inserts 16. The cores 5 can also only be equipped with inserts 16 after the inductive heating. In this way, damage to the inserts 16 due to the influence of the inductive heating device 6 can be avoided. This procedure is to be preferred in particular in the case of inserts 16 having an electrical or electronic function.

In the injection molding device 1 shown in the drawings, the cores 5 serve not only as shaping parts, but also as holders for the inserts 16 and as means of transport for inserting the inserts 16 into the mold cavities 4 of the injection molding tool 3. Inside the mold cavities 4, the inserts 16 arranged on the cores 5 are then at least partially overmolded with plastics material.

For the inductive heating of the cores 5, the cores 5 and the heating coils 9 are arranged relative to one another at a distance of 1-5 mm, in particular 0.5-2 mm and particularly preferably at a distance of 0.2 mm to 1 mm.

This is done using the already mentioned positioning device 12 of the injection molding device 1. FIG. 5 illustrates the distance between the inductive heating coil 9 and a core 5 in the heating position inside the heating coil 9.

The plastics parts 2, which can be produced according to the method on the injection molding device 1, are coiled-shaped parts, such as coiled plastics springs. The plastics springs can, for example, have a ratio of coil length and coil width B between 20:1 and 100:1, in particular 50:1. The plastics springs can, for example, have a ratio of coil thickness D, which can be measured transversely to the longitudinal axis of the plastics spring, to coil width B, which can be measured in the direction of the longitudinal axis of the plastics spring, of between 1:2 and 1:10, in particular approximately 1:5.

The cores 5 are also used as means of transport for removing the plastics parts 2 from the injection molding tool 3.

The plastics parts 2 initially remain on the cores 5 after the injection molding and cool there.

When the plastics parts 2 on the cores 5 cool, the cores 5 act as heat sinks, since the inductive heating of the cores 5 primarily results in an inductive heating of the shaping surface 23 of the cores 5, but an inner region 24 of the cores 5 remains comparatively cold.

A cooling of the plastics parts 2 on the cores 5 after the injection molding is promoted by a temperature gradient that occurs between the shaping surface 23 and the inner region 24 of the corresponding core 5.

The invention relates to improvements in the field of injection molding technology. Among other things, a method for injection molding plastics parts 2 is proposed as an improvement, wherein liquefied plastics material is injected into a mold cavity 4 of an injection molding tool 3 equipped with a core 5 to produce a plastics part 2. The method is characterized in that the core 5 is inductively heated before the plastics material is injected.

1. -28. (canceled)

29. A method for injection molding a plastic part, comprising:
providing an injection molding tool and a core insertable into the injection molding tool to define a mold cavity;
inductively heating the core outside of the injection molding tool;
inserting the inductively heated core into the mold cavity; and
injecting an injectable plastics material into the mold cavity to produce a plastic part.

30. The method of claim 29, wherein the core includes at least one shaping surface, wherein the core is inductively heated to a temperature between 50 °C and 100 °C.

31. The method of claim 30, wherein the temperature is between 60 °C and 80 °C.

32. The method of claim 29, wherein the core is inductively heated with an inductive heating coil of an inductive heating device.

33. The method of claim 32, wherein the core is arranged inside the inductive heating coil.

34. The method of claim 33, wherein the inductive heating coil is placed over the core or the core is inserted into the inductive heating coil.

35. The method of claim 32, wherein the core and an inductive heating coil are arranged relative to one another for inductively heating the core at a distance (A) of 1-5 mm.

36. The method of claim 29, wherein a surface of the core is inductively heated superficially.

37. The method of claim 29, wherein the core is at least substantially without cavities.

38. The method of claim 29, wherein during the inductively heating step, a temperature gradient is set between a surface of the core and an inner region of the core that is heated less than the surface or not at all.

39. The method of claim 29, wherein during the inductively heating step, a temperature of the core is monitored using a temperature sensor and/or is regulated by a control unit.

40. The method of claim 29, further comprising inserting at least one insert into the mold cavity prior to the injecting step, wherein the at least one insert is at least partially over molded with the core with the plastics material.

41. The method of claim 39, wherein the at least one insert is arranged on the core and/or is inserted with the core into the mold cavity.

42. The method of claim 29, wherein the plastic part comprises a coil-shaped plastic part.

43. The method of claim 42, wherein the coil-shaped plastic part comprises a ratio of coil length to coil width (B) of between 20:1 and 100:1.

44. The method of claim 42, wherein the coil-shaped plastic part comprises a ratio of a coil thickness (D) to a coil width (B) of between 1:2 and 1:10, the coil thickness (D) measured transversely to a longitudinal axis of the coil-shaped plastic part, the coil width (B) measured in a direction of the longitudinal axis.

45. The method of claim 29, further comprising transporting the plastic part with the core from the injection molding tool.

46. The method of claim 29, further comprising cooling the plastic part on the core after the injecting step.

47. An injection molding device for injection molding a plastic part, comprising:
an injection molding tool having a mold cavity;
a core;
an inductive heating device; and
a control unit configured to execute computer-readable instructions that cause the control unit to:
inductively heat the core with the inductive heating device outside of the injection molding tool;
insert the inductively heated core into the mold cavity; and
inject an injectable plastics material into the mold cavity to produce a plastic part.

48. The device of claim 47, wherein the control unit is configured to transport the plastic part with the core from the injection molding tool.
